(19) United States
(12) Patent Application Publication
(10) Pub. No.: US 2014/0007507 A1
(43) Pub. Date: Jan. 9, 2014

(54) WINDOW REGULATOR

(71) Applicant: Taiji Umemura, Hyogo (JP)

(72) Inventor: Taiji Umemura, Hyogo (JP)

(73) Assignee: HI-LEX CORPORATION, Takarazuka-shi (JP)

(21) Appl. No.: 13/807,806

(22) PCT Filed: May 31, 2011
(86) PCT No.: PCT/JP2011/062549

§ 371 Date: Sep. 25, 2013

(30) Foreign Application Priority Data
Jun. 30, 2010 (JP) 2010-149663

(51) Int. Cl. E05F 15/00; E05F 11/48

(52) U.S. Cl. CPC E05F 15/00; E05F 11/48
USPC 49/349

(57) ABSTRACT

Disclosed is a window regulator that reduces thrust-down noises by minimizing the moment of rising even when the window glass reaches the lower edge, and improves the durability of an elastic member. The window regulator (10) is provided with: a carrier plate (12) that holds the window glass; a guide rail (11) that freely guides the carrier plate up and down; a direction switching member (13) disposed at the top end of the guide rail; inner cables (16, 17) that pass over the direction changing member, and are connected to the carrier plate (12); and a drive mechanism (14) that reciprocatingly drives the inner cables. An elastic member (28) is disposed on the lower edge of the carrier plate (12). A receiving section (27), which comes into contact with the elastic member (28) and controls the descent of the carrier plate, is disposed on the drive mechanism (14) housing (25). The receiving section (27) has an inclined surface (44) inclined in such a manner as to rise with increasing distance from the guide rail.

### FIELD OF INVENTION

This invention relates to a window regulator. More specifically it relates to a window regulator for hoisting the window glass set in the door or etc. of the automobile.

### BACKGROUND ARTS

A window regulator is shown in the Patent document 1. This window regulator has a guide rail, a carrier plate which carries the window glass and moves up and down along the guide rail, and a driving unit which hoists the carrier plate. The driving unit is set on the bottom of the guide rail. The carrier plate has a cushion rubber (stopper) which hits the housing of the driving unit when the carrier plate is descended to the limit. The cushion rubber comprises the fixing part fixed to the carrier plate, and the contacting part which elastically deforms when contacts the housing while the carrier plate is at the limit position. The width of the contacting part is formed wider than the width of the fixing part and the width of the contacting part progressively decreases in downward.

In this window regulator, the contacting part of cushion rubber is made to be in tapered form where the width decreases facing top. Therefore the elastical deformation of the contacting part is accelerated when the contacting part meets the housing of the driving unit, and prevents the hammering sound of the contact. Further, the degree of the elastical deformation of the contacting part is further expedited by aligning the contacting part and the fixing part perpendicular to the hoisting direction (offset against the hoisting direction) to form a space between the contacting part and the carrier plate. In addition, the front end side and the fixing part side (guide rail side) of the contacting part is formed in a tapered surface, so as to prevent the lopsided contact between the contacting part and the housing of the driving unit. This will enhance the durability and prevent the interference of the carrier plate and the housing of the driving unit.

Patent document 2 discloses a window regulator where a cushion rubber having prism shape is press inserted into the bottom surface of the carrier plate. Patent document 3 discloses a window regulator where a driving unit is not set on the bottom of the guide rail, instead a contacting surface is formed at the periphery of the bottom of the guide rail with a right angle against the guide rail.

### PRIOR ART

### Patent Document

Patent Document 1: Japanese Published Patent Application No. 2007-177421

Patent Document 2: Japanese Published Patent Application No. 2010-112016

Patent Document 3: Japanese Published Patent Application No. 2001-49949

### DISCLOSURE OF THE INVENTION

### Problem to be Solved by the Invention

In a window regulator of the automobile, a guide rail is curved in which the convex side faces outside. Therefore, when a carrier plate which slides along the guide rail is pulled upward by the inner cable, a bottom of a carrier plate receives a moment which separates the carrier plate from the guide rail or a moment which rises the bottom of the carrier plate. Thus, when the window glass reaches the bottom, a cushion rubber tends to move in a way to avoid the contact with the contacting surface formed in a right angle against the guide rail, and collides directly with the housing. In this case, the contacting area between the cushion rubber and the contacting surface will be lessen, resultantly the hitting sound of the collision when the window glass reaches the bottom will be loud. This also tends to happen with the window regulator of Patent document 1.

Further, in the Patent document 1, the front end of the contacting part of the cushion rubber which is the fixing part side (guide rail side), is formed with a tapered surface to prevent the collision with the housing. However, the contacting part of the cushion rubber and the contacting surface of the housing contact in an off set way the cushion rubber receives a shear force instead of a compression force, which causes a crack in the cushion rubber.

A present invention is to suppress the moment which rises the bottom of the carrier plate when the window glass is moved to the bottom, thus to reduce the hitting sound of the window regulator, and to improve the durability of the cushion rubber by preventing the cushion rubber from receiving the shear force.

### Means of Solving the Problems

A window regulator of this invention features, a carrier plate holding a window glass, a guide rail guiding the carrier plate movably in elevating/lowering direction, a direction-changing member fixed on the top end portion and/or the bottom end portion of the guide rail, an inner cable wound around the direction-changing member and fixed to the carrier plate, and a driving mechanism having a drum rewinding the inner cable and a driving motor for rotating the drum, where an elastic member is fixed to the carrier plate, and a receiving part is formed around the bottom end portion of the guide rail for regulating the declination of the carrier plate by contacting with the elastic member, and where the receiving part has an inclined surface which is gradually inclined upwardly on the basis of a surface perpendicular to the guide rail as being separated from the guide rail.

### Effects of the Invention

(1) In the window regulator of this invention, the receiving part which contacts with the elastic member has the inclined surface which is gradually inclined upwardly on the basis of a surface perpendicular to the guide rail as being separated from the guide rail, therefore, the reverse moment against the moment which rises the bottom of the carrier plate, is generated to the bottom of the carrier plate from the inclined surface of the receiving part when the elastic member of the carrier plate contacts the receiving part while the window glass is descended. Resultantly, the moment which rise the bottom of the carrier plate can be suppressed. Further, the contacting area between the elastic member and the receiving part will be enlarged. Resultantly the absorption of the collision can be increased and the hitting sound of the window regulator can be reduced. Moreover, the force energized to the elastic member will be compressive load rather than shear force, durability of the elastic member can be improved.
(2) When the elastic member has an fixing part fixed to the carrier plate and a contacting part contacting with the receiving part, and the contacting part has an approximately triangle prism configuration being convex downward in front vision, the contacting area will further increases, and the suppression effect of the moment and the reduce effect of the hitting sound will be further improved.
(3) When apart of the contacting part close to the guide rail is chamfered so as a chamfered surface of the contacting part is gradually declined downwardly on the basis of a surface perpendicular to the guide rail, the contacting area of the elastic member will also increases, and the suppression effect of the moment and the reduce effect of the hitting sound will be further improved.
(4) When the elastic member is fixed to the carrier plate by fitting the elastic member to the carrier plate from an opposite side of the carrier plate facing the guide rail, the size limitation of the elastic member will be small. Therefore, the contacting surface contacting with the receiving part can be enlarged. As a result, the hitting sound between the receiving part and the contacting surface can be further reduced. Moreover, the full surface of the elastic member will contact with the receiving part and receives compressive load, so the durability life can be extended.
(5) When the inclined surface of the receiving part is inclined at 10 to 20 degree to a surface perpendicular to the guide rail, the moment which rises the bottom of the carrier plate generated to the carrier plate can be suppressed efficiently.
(6) When a portion of the receiving part close to the guide rail is essentially perpendicular against the guide rail, and the inclined part is formed at a front end of the receiving part, the moment which rises the bottom of the carrier plate generated to the carrier plate can be suppressed efficiently.
(7) When the chamfered surface is inclined at 20 to 30 degree to the surface perpendicular to the guide rail, the moment which rises the bottom of the carrier plate generated to the carrier plate can be suppressed efficiently and it will assist the reduction of the hitting sound and improvement of the durability.
(8) When the guide member is fixed only on the top end portion of the guide rail, the drum is fixed on the bottom end portion of the guide rail, and the receiving part is formed on the outer periphery of the driving mechanism, the configuration of the window regulator can be simplified. Further, there is a lot of flexibility in designing of the receiving part.

### BRIEF DESCRIPTION OF DRAWINGS

FIG. 1 is a front view showing an embodiment of the window regulator guide of this invention.

FIG. 2 is an expanded front view of the relevant part of the window regulator of FIG. 1.

FIG. 3 is an expanded side view of the relevant part of the window regulator of FIG. 1.

FIG. 4a and FIG. 4b are a side view and a front view of the elastic member used in window regulator of FIG. 1, respectively.

FIG. 5 is a front view of the window regulator of FIG. 1, where the carrier plate is at the bottom position.

FIG. 6 is a side view of the window regulator of FIG. 1, where the carrier plate is at the bottom position.

FIG. 7 is a side over view of the window regulator of FIG. 1.

### EMBODIMENT OF THE INVENTION

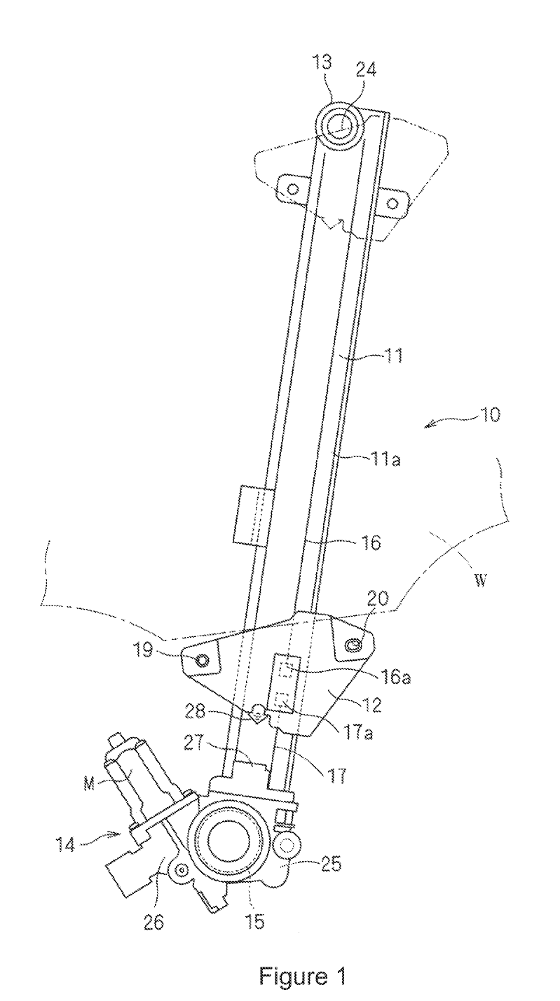

A window regulator 10 of FIG. 1 has a guide rail 11 extending up and down, a carrier plate 12 guided slidably by the guide rail, a direction-changing member 13 which guide the direction of the inner cable fixed at the top of the guide rail, and a driving unit 14 fixed at the bottom of the guide rail. The window regulator 10 further has an ascending inner cable 16 and a descending inner cable 17. One end of the ascending inner cable 16 is fixed to the carrier plate 12. The ascending inner cable 16 is extended upward from the carrier plate 12 to the direction-changing member 13 where it is guided to extend downward. After the direction-changing member, it is extended downward to the driving member where the periphery of the other end is wound around the drum 15 of the driving unit 14 and fixed. One end of the descending inner cable 17 is fixed to the carrier plate 12. The descending inner cable 17 is extended downward from the carrier plate 12 to the driving member where the periphery of the other end is wound around the drum 15 and fixed.

The window regulator 10 is fixed to the inner space of the door of the automobile for hoisting the window glass of the door. FIG. 1 shows the condition where it is seen from the outside of the automobile. The carrier plate 12 for supporting the bottom of the window glass is fixed to the outside of the guide rail

The guide rail 11 is usually made of metal plate, where the guiding protrusion 11a is formed along the periphery of one side edge of the long metal plate to groove with the guiding channel of the carrier plate 12 and the rib is formed along the other side edge. The rib is formed by bending the periphery of the other side edge in approximately right angle. The guiding protrusion 11a is twofolded bending part where it is formed by interfolding the metal plate. The guide rail 11 is curved in arc where the convex side faces the outside of the automobile and is accommodated to the trajectory of the window glass. Further, the guide rail set in the slant where the top of the guide rail is tilted to the back side (right side in FIG. 1) of the automobile.

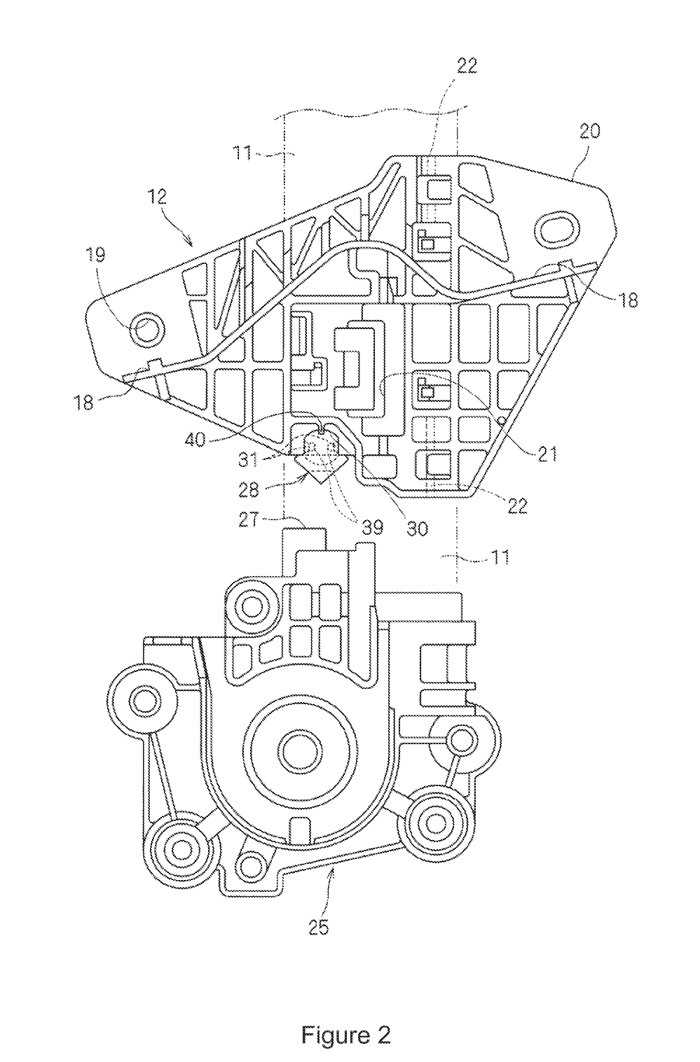

As shown in FIG. 2, the carrier plate 12 has an engaging step 18 and attachment hole 19, 20 for supporting the bottom of the window glass. Further, the recessed part 21 for fixing the cable end 16a, 17a of the inner cable 16, 17 is formed at the center and the guiding channel 22 which slides the guiding protrusion 11a is formed around the recessed part. The carrier plate 12 may be formed by insert molding the synthetic resin into the metal plate or by forming the entire shape with the synthetic resin and insert into or fix the reinforcement material such as embedding nut or grommet made of metal.

The direction-changing member 13 is a pulley rotatably fixed to the guide rail 11 using the axis member 24, where the ascending inner cable 16 is wound around. The slide guide having a guide groove of approximately arc, where the ascending inner cable 16 slide, may be used substitute for the pulley.

The driving unit 14 has a housing 25 which support the rotating drum 15, a motor M fixed to the housing, a reducer 26 which transmit the rotating power with reduced speed to the drum 15. The worm reducer may be used for such a reducer. The slit to insert the bottom of the guide rail 11 for fixing and the receiving part 27 to contact with the bottom of the carrier plate 12 for regulating the declination of the carrier plate 12 are formed on the top surface of the housing 25. The receiving part 27 is a part where the elastic member 28 which is fixed to the periphery of the bottom of the carrier plate 12, contacts. The elastic member 28 is fixed to decrease the hitting sound, therefore, a synthetic resin having elasticity such as polyurethane, a synthetic rubber such as chloroprene, or a cushion member which has buffering effect may be used.

In this embodiment, the driving unit 14 is fixed on the bottom of the guide rail, however the driving unit 14 may be set around the center line of the top and bottom of the guide rail. For example, the driving unit 14 may be set on the bracket which extend laterally from the mid point of the guide rail, or may be set on the inner panel of the door. In this case, direction-changing member to guide the direction of the descending inner cable 17 is fixed to the bottom and the receiving part 27 is fixed to the guide rail 11 or the inner pane.

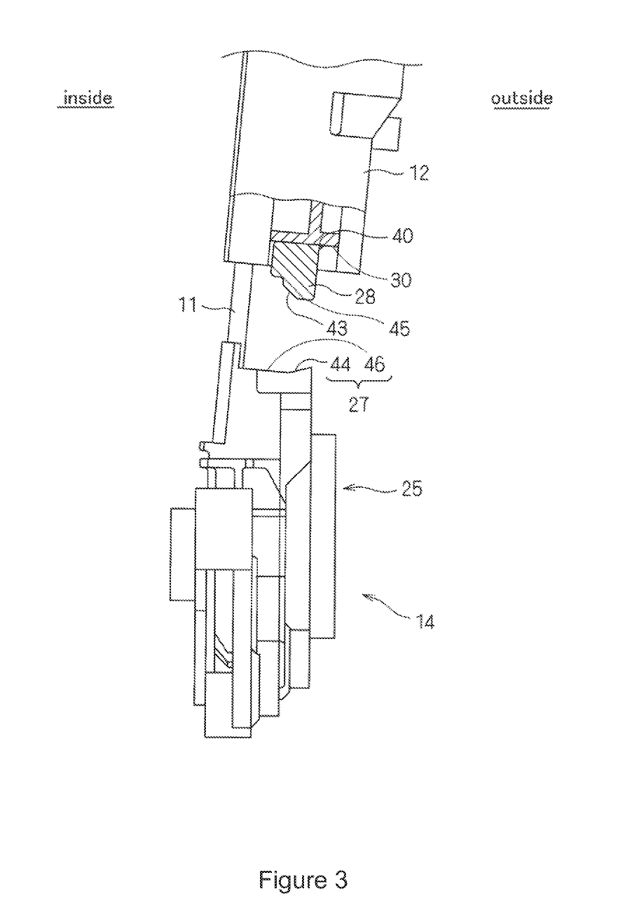

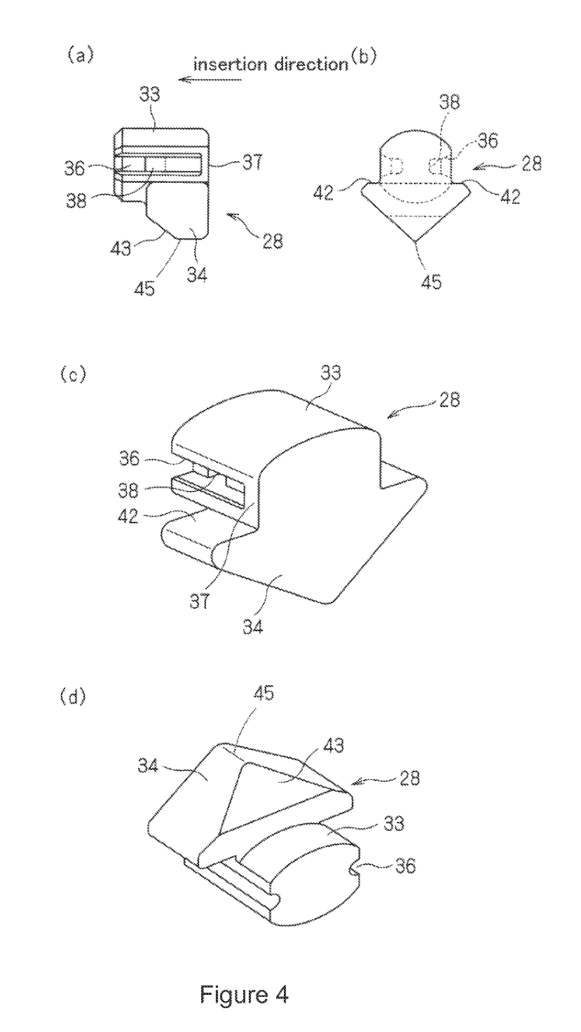

Like shown in FIGS. 2 and 3, a fitting groove 30 is formed around the bottom of the carrier plate 12 for inserting and fitting the elastic member 28. The fitting groove 30 has an opening which faces downward, and a pair of guide projection 31 formed right and left of the inner side wall. The guide projection 31 is for stopping the elastic member 28 from moving downward and frontward (right side of FIG. 4a). Further, the fitting groove 30 is configured to have the elastic member 28 to be inserted into the carrier plate 12 from the opposite surface facing the guide rail 11 (right side of the FIG. 3). However, it may be configured to have the elastic member 28 inserted from the guide rail side.

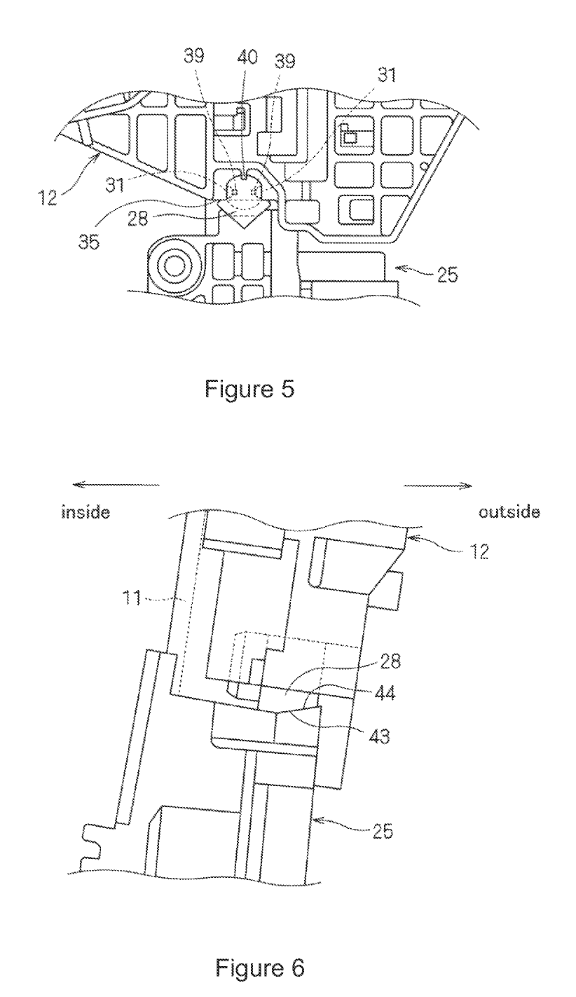

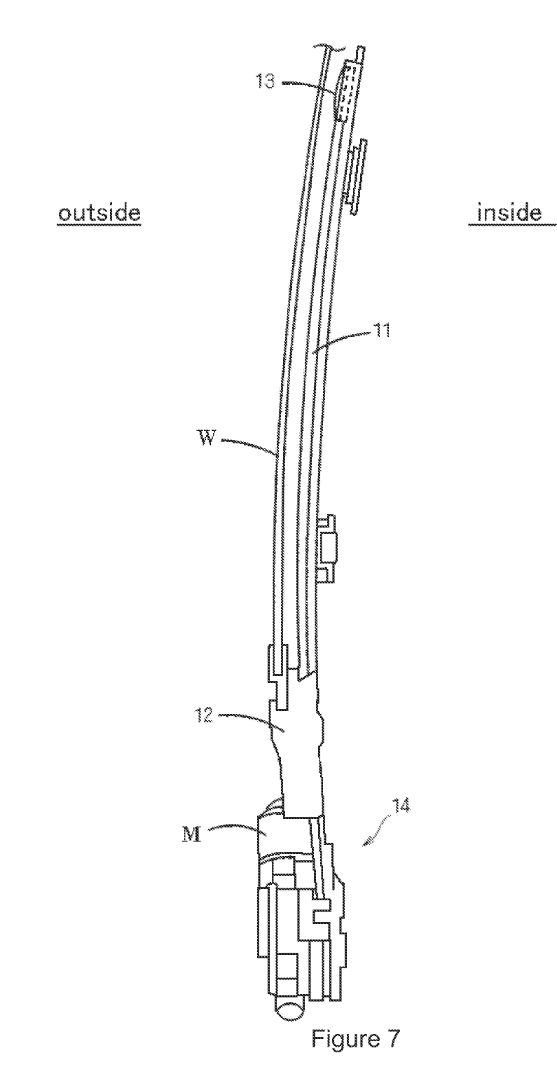

Like shown in FIG. 4a, 4b, the upper part of the elastic member 28 extending front and back having approximately columned shape is fixing portion 33 and lower part of the elastic member 28 having approximately triangle prism is a contacting portion 34. A front and back length of the fixing portion 33 is longer than that of the contacting portion 34, and the fixing portion 33 is projected from the back end of the contacting portion 34. The side face of the fixing portion 33 is formed flat and the pair of the guiding groove 36 is formed on the side face. The guiding groove 36 is opened in front (left side of FIG. 4a) and has a fitting wall 37 at the back end. Further, deeper fitting groove 38 is formed in between in the guiding groove 36. And fitting protrusion 39 fitting with the deeper fitting groove 38 is formed in mid course of the guiding protrusion 31 (see FIG. 5). The fitting protrusion 39 fits with the fitting groove 38 or the fitting wall 37 contacts with the back end of the fitting protrusion 31, when the fixing portion 33 of the elastic member is inserted into the fitting groove 30. This prevents the fixing portion 33 to be further inserted.

The top surface of the fitting groove 30 is equipped with a fitting claw 40 for retaining the inserted elastic member (see FIG. 3). Therefore, the elastic member 28 can be easily inserted from the opposite side of the guide rail 11, and prevents the drop out of the elastic member without using adhesion. The adhesion may be used, but it is preferable not to use the adhesion for allowing the free elastic deformation of the elastic member 28. In this embodiment, the fitting protrusion and the fitting groove 37 regulate the insertion of the elastic member 28 by fitting. However, a wall may be formed at the back of the fitting groove 30 of the carrier plate 12 for regulating the ingression of the elastic member 28. It is preferable not to form such a wall, because the molding of the synthetic resin is much easier.

Like shown in FIG. 4b, the width of the contacting part 34 is wider than the width of the fixing part 33 in front vision. The top surface 42 of the contacting part 34 protruding from the fixing part is formed in flat and contact with the bottom surface 35 of the carrier plate. Therefore, it can receive the impact force directing upward. The contacting part 34 has approximately triangle prism where the convex side faces downward, and it can be seen like arrow from the front view like shown in FIG. 4b. Further, like shown in FIG. 4a, the front side (the guide rail side) of the bottom of the contacting part 34 is chamfered so as a slanted surface (the chamfered part) 43 is gradually declined downwardly as the distance from the guide rail increases of the side view like shown in FIG. 4a. On the back side of the contacting part 34, the bottom 45 which is an edge line of the triangle prism is formed perpendicular to the guide rail. The slanted angle of the chamfered part 43 is about 20 to 30 degree basing a surface perpendicular to the guide rail.

On the other hand, an inclined surface 44 which contacts with the bottom 45 of the contacting part 34 of the elastic ace caber 28 is formed on the receiving part 27 of the housing 25. The inclined surface 44 is slanted upwardly as the distance from the guide rail 11 increases. The inclined surface 44 may not be slanted in sequence and may includes such like a flat part in the middle, as long as the effect of the inclined surface can be achieved. The inclination angle is 10 to 20 degree basing a surface perpendicular to the guide rail. Further, the base part 46 which is a guide rail side of the receiving part 27 is approximately perpendicular to the guide rail and has inclined surface 44 at the top.

The window regulator 10 having the composition of above closes the window by rotating the motor M of the driving mechanism 14 in one way. Therefore the drum 15 will rotate in one way receiving the power through the reducer, and the cable formed in loop composed of the ascending inner cable 16 and the descending inner cable 17 rotates in one way. The carrier plate 12 is ascended in upward, and resultantly the window glass is carried upward. On the other hand, when the motor M is rotated in other way, the carrier plate 12 is been lowered and opens the window. When the window glass reached the bottom, the elastic member 28 of the carrier plate 12 abuts the receiving part 27 of the housing 25 and as a result descending of the window glass stops.

In this condition, the inclined chamfered part 43 of the elastic member 28 abuts the flat base part 46 of the receiving part 27 and the bottom 45 of the triangle prism which is a back part of the contacting part 34 abuts the inclined part 44 of the receiving part 27. However, the border of the chamfered part 43 of the elastic member 28 and the bottom 45 of the triangle prism, and the border of the base part 46 and the inclined surface 44 does not have to be on the same position. Because the inclined surface 44 of the receiving part 27 is slanted upwardly as the distance from the guide rail increases, a moment to force the bottom 45 to the guide rail side is generated to the carrier plate 12, when the elastic member 28 abuts with the receiving part 27. In other word, a moment opposite to the moment to force the bottom of the carrier plate upward is generated. Therefore, the elastic member 28 as a whole receives a compressing load instead of a shear load. Resultantly, the durability of the elastic member 28 enhances. Further, because the compressed part of the elastic member increases, the sound reducing effect of the hammering or slamming decreases.

Moreover, because the elastic member 28 fixed to the carrier plate 12 is inserted from the opposite side of the guide rail, the size of the elastic member will not be limited when designing. Thus, the contacting area between the elastic member 28 and the receiving part can be enlarged. This can further reduces the hammering sound. However, the elastic member may be inserted from the guide rail side.

### DESCRIPTION OF THE NUMERAL

10 window regulator
11 guide rail
11a protrusion
12 carrier plate
13 direction-changing member (pulley)
14 driving unit
15 drum
16 ascending inner cable
17 descending inner cable
16a, 17a cable end
18 engaging step
19, 20 attachment hole
21 recessed part
22 guiding channel
24 axis member
25 housing
M motor
26 reducer
27 receiving part
28 elastic member
30 fitting groove
31 guide projection
33 fixing portion
34 contacting portion
35 bottom surface
36 guiding groove
37 fitting wall
38 fitting groove
39 fitting protrusion
40 fitting claw
42 top surface
43 chamfered part
44 inclined surface
45 bottom
46 base part

1. A window regulator comprising,
a carrier plate holding a window glass,
a guide rail guiding the carrier plate movably in elevating/lowering direction,
a direction-changing member fixed on a top end portion and/or a bottom end portion of the guide rail,
an inner cable wound around the direction-changing member and fixed to the carrier plate, and
a driving mechanism having a drum rewinding the inner cable and a driving motor for rotating the drum;
an elastic member is fixed to the carrier plate;
a receiving part is formed around the bottom end portion of the guide rail for regulating the declination of the carrier plate by contacting with the elastic member;
the receiving part has an inclined surface which is gradually inclined upwardly on the basis of a surface perpendicular to the guide rail as being separated from the guide rail.

2. The window regulator according to claim 1,
wherein the elastic member has an fixing part fixed to the carrier plate and a contacting part contacting with the receiving part,
wherein the contacting part has an approximately triangle prism configuration being convex downward in front vision.

3. The window regulator according to claim 1,
wherein a part of the contacting part close to the guide rail is chamfered so as a chamfered surface of the contacting part is gradually declined downwardly on the basis of a surface at right angle to the guide rail as the distance from the guide rail.

4. The window regulator according to claim 1,
wherein the elastic member is fixed to the carrier plate by fitting the elastic member to the carrier plate from an opposite side of the carrier plate facing the guide rail.

5. The window regulator according to claim 1,
wherein the inclined surface of the receiving part is inclined at 10 to 20 degree to a surface perpendicular to the guide rail.

6. The window regulator according to claim 1,
wherein a potion of the receiving part close to the guide rail is essentially perpendicular against the guide rail, and the inclined surface is formed at a front end of the receiving part.

7. The window regulator according to claim 3,
wherein the chamfered surface is inclined at 20 to 30 degree to the surface at right angle to the guide rail.

8. The window regulator according to either 1 to 7,
wherein the direction-changing member is fixed only on the top end portion of the guide rail,
the drum is fixed on the bottom end portion of the guide rail, and
the receiving part is formed on the outer periphery of the driving mechanism.
